(19) United States
(12) Patent Application Publication
(10) Pub. No.: US 2009/0167632 A1
(43) Pub. Date: Jul. 2, 2009

(54) SYSTEMS HAVING TWIN DISPLAY MONITORS

(75) Inventor: Tai-Sheng (Andrew) Han, Fullerton, CA (US)

Correspondence Address: IPxLAW Group LLP, 95 South Market Street, Suite 570, San Jose, CA, 95113, US

(73) Assignee: EVGA Corporation, Brea, CA (US)

(21) Appl. No.: 11/966,193

(22) Filed: Dec. 28, 2007

(51) Int. Cl. G09G 5/00

(52) U.S. Cl. 345/1.1

(57) ABSTRACT

Systems for displaying a plurality of images. A system includes: a hollow post that is adapted for connection to a support means and has a recessed portion; and a pair of pivot arms that include mounting protrusions pivotally mounted in the recessed portion. Each pivot arm is adapted to pivot about a first axis parallel to a longitudinal axis of the hollow post. The system also includes a pair of mounting assemblies respectively affixed to the pivot arms and a pair of monitors respectively secured to the mounting assemblies. Each mounting assembly is adapted to allow one of the monitors to rotate relative to one of the pivot arms about a second axis substantially perpendicular to the first axis.

### CROSS REFERENCE TO RELATED APPLICATIONS

This application is related to the copending U.S. patent application Ser. No. ______, entitled “Systems Having Detachable Twin Display Monitors” by Han, filed on Dec. 28, 2007, which is incorporated by reference in its entirety.

### BACKGROUND OF THE INVENTION

The present invention generally relates to electronic display systems and, more particularly, to a novel display system having twin display monitors.

With the advance of computer technology, a computer allows the user to run multiple application programs simultaneously and display the graphic user interfaces (GUI) of the programs on a display screen. In general, a larger display area may provide enhanced flexibility in arranging GUIs and other images on the screen. Thus, various approaches to increase the display area have been developed. For instance, U.S. Pat. No. 6,222,507 to Gouko discloses a personal computer having multiple display panels to increase the total display area. In the Gouko '507 patent, the computer includes a primary display panel and two or more secondary display panels that are disposed on opposite sides of, or above the primary panel and can be slid to be contained into the primary display panel. As such, the secondary display panels are smaller than the primary display panel, which may limit the utility of the multiple panels. For example, two electronic gamers playing the same game with each other may need two sets of identical operational environments, such as identical display panels having the same pixel resolution and screen size, identical input controls, speakers, etc., so that the gamers can play the game under the equal condition. Due to the difference in the size between the primary and second display panels, the system disclosed in the Gouko '507 patent may not be suitable for such applications. Also, as the personal computer is designed for one user, the second user watching the secondary display panel may not be able to have the same access to the computer as the primary user, much less the control over the images on the second display panel. For another example, a manager interviewing an employee may need to turn the manager's computer screen into a side way so that they can view the screen simultaneously or even ask the employee to move behind him so that the employee can watch the monitor screen over the manager's shoulder. Thus, there is a strong need for a computer system having two identical display panels, being able to provide the same level of access to the system for two users simultaneously, and allowing two users to view face to face the identical screen shot or even a specific pixel with an easy screen pivoting and/or rotation.

### SUMMARY OF THE INVENTION

In one aspect of the present invention, a system for displaying a plurality of images includes: a hollow post that is adapted for connection to a support means and has a recessed portion; and a pair of pivot arms that include mounting protrusions pivotally mounted in the recessed portion. Each pivot arm is adapted to pivot about a first axis parallel to a longitudinal axis of the hollow post. The system also includes a pair of mounting assemblies respectively affixed to the pivot arms and a pair of monitors respectively secured to the mounting assemblies. Each mounting assembly is adapted to allow one of the monitors to rotate relative to one of the pivot arms about a second axis substantially perpendicular to the first axis.

In another aspect of the present invention, a system for displaying a plurality of images includes: a hollow post adapted for connection to a support means; a pair of mounting assemblies affixed to the hollow post; and a pair of monitors respectively secured to the mounting assemblies. Each mounting assembly is adapted to allow a monitor to pivot about a first axis substantially parallel to the longitudinal axis of the hollow post and to rotate about a second axis substantially perpendicular to the first axis.

### BRIEF DESCRIPTION OF THE DRAWINGS

FIG. 1 shows a perspective view of a twin view system in accordance with one embodiment of the present invention;

FIG. 2 shows a schematic exploded perspective view of a post of the system in FIG. 1;

FIG. 3A shows a schematic perspective view of a pivot arm and a monitor of the system in FIG. 1;

FIG. 3B shows another schematic perspective view of the pivot arm in FIG. 3A;

FIG. 4 shows a schematic cross sectional view of the pivot arm in FIG. 3B, taken along the line 4-4;

FIG. 5A shows a schematic side cross sectional view of the region A in FIG. 3A;

FIG. 5B shows a schematic perspective view of the mounting assembly in FIG. 5A;

FIG. 6A shows a schematic exploded perspective view of another embodiment of a post of a type that might be used in the system of FIG. 1 in accordance with the present invention;

FIG. 6B shows a schematic exploded perspective view of another embodiment of a post of a type that might be used in the system of FIG. 1 in accordance with the present invention;

FIG. 7 shows a schematic perspective view of still another embodiment of a post of a type that might be used in the system of FIG. 1 in accordance with the present invention;

FIG. 8A shows a schematic perspective view of an embodiment of a pivot arm of a type that might be used in the system of FIG. 1 in accordance with the present invention;

FIG. 8B shows a schematic cross sectional view of the pivot arm in FIG. 8A, taken along the line 8B-8B;

FIG. 9 shows a perspective view of a twin view system in accordance with another embodiment of the present invention;

FIG. 10 shows a schematic cross sectional view of the region B in FIG. 9;

FIG. 11 shows a schematic perspective view of the mounting assembly in FIG. 10;

FIG. 12 is a perspective view of an embodiment of a base of a type that might be used in a twin view system in accordance with the present invention;

FIG. 13A is an exploded perspective view of another embodiment of a post or stand assembly in accordance with the present invention;

FIG. 13B is an exploded perspective view of yet another embodiment of a post or stand assembly in accordance with the present invention;

FIG. 14 is a broken partial cut away front view of an alternative embodiment of a twin view system in accordance with the present invention;

FIG. 15 is a perspective view of a mounting assembly in FIG. 14;

FIG. 16A is a broken partial cut away front view of another alternative embodiment of a twin view system in accordance with the present invention;

FIG. 16B is an exploded view of an embodiment of a hinge mechanism in the twin view system of FIG. 16A;

FIG. 17 shows a perspective view of a twin view system in accordance with yet another embodiment of the present invention;

FIG. 18 shows a perspective view of a twin view system in accordance with a further embodiment of the present invention;

FIG. 19A shows a schematic perspective view of a pivot arm and a monitor of the system in FIG. 18;

FIG. 19B shows another schematic perspective view of a pivot arm and a monitor in FIG. 18; and

FIG. 20 shows an embodiment of a computer of a type that might be employed in accordance with the present invention.

### DETAILED DESCRIPTION OF THE INVENTION

The following detailed description is of currently contemplated modes of carrying out the invention. The description is not to be taken in a limiting sense, but is presented merely for the purpose of illustrating the general principles of the invention, since the scope of the invention is best defined by the appended claims.

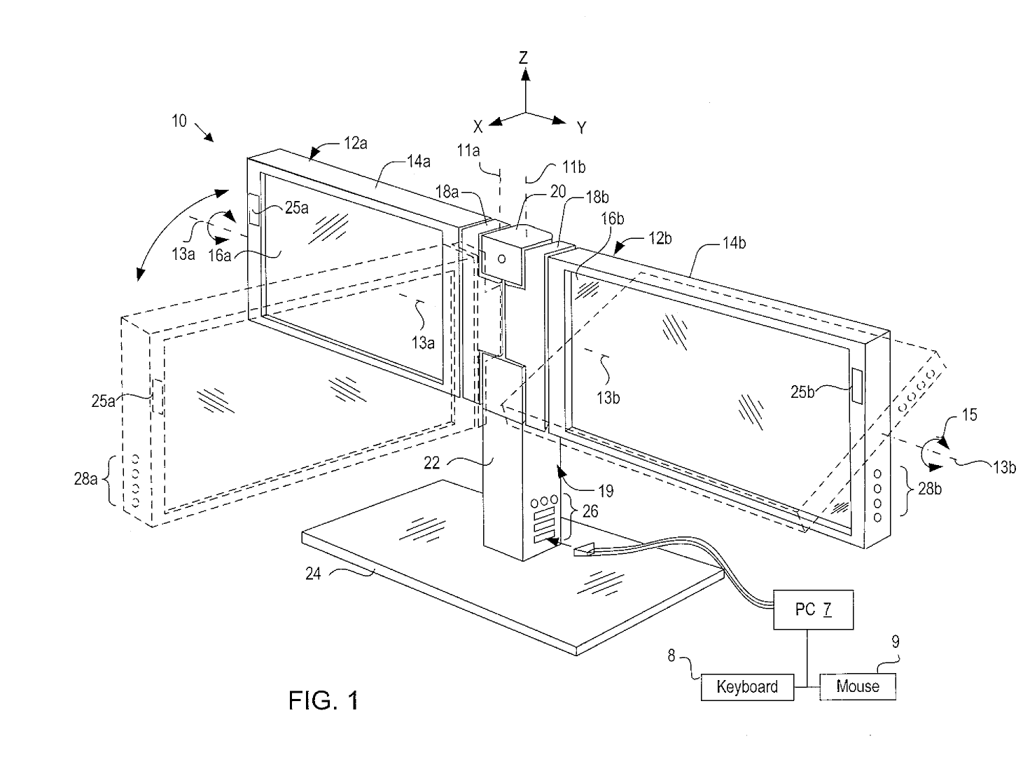

Referring now to FIG. 1, there is shown at 10 a perspective view of a twin view system in accordance with one embodiment of the present invention. As depicted, the system 10 may include a base 24; a post 19 secured to the base 24 and having an upper section 20, and a lower section 22 with input/output (or communication) ports 26; a pair of pivot arms 18a, 18b pivotally mounted to the upper section 20 and rotatable about axes 11a and 11b; and a pair of monitors 12a, 12b rotatably mounted to the pivot arms 18a, 18b and rotatable about axes 13a and 13b. Each monitor may include a display screen 16a (or 16b) and a frame 14a (or 14b) for supporting the display screen. In one exemplary embodiment, the frames 14a, 14b may provide mechanical support to the display screens 16a, 16b and include pertinent electrical connections extending from the input/output ports 26. In another exemplary embodiment, the frames 14a, 14b may each house independent computer, including thus one or more CPUs therein (not shown).

The monitors 12a, 12b as described have dual motion relative to the base 24, namely pivotal motion and rotational motion. The pivot arms 18a, 18b are rotatable relative to the post 19 about axes 11a, 11b parallel to the z-axis, allowing each of the monitors 12a, 12b to pivot within a preset angular interval, preferably about 90 degrees. However, as will be disclosed below, means may be provided for restricting the swing so as to avoid unintentional unbalance of the supporting assembly. (Hereinafter, the z-axis represents the axis substantially parallel to the longitudinal axis of the post 19.) However, notwithstanding the restrictions, the monitors 12a, 12b may be permitted to pivot into a closed position, allowing the display screens 16a, 16b to face each other, when it is desired to close the system 10 for protection, transport or the like. A suggested by the arrows 15, the monitors 12a, 12b may be also rotatable about the axes 13a, 13b within a preset angular interval, preferably 180 degrees so that one or both of the screens can be viewed from the side opposite that depicted.

The user can operate the system 10 to use monitors 12a, 12b in a cloning (or mirroring) mode or in an extended mode. In the cloning mode, the monitors 12a, 12b display the same images. In the extended mode, one monitor may provide additional desk top area and each monitor may have different settings (resolution, color, refresh rate). In one exemplary operation of the system 10, one of the monitors, say 12b, may be rotated by 180 degrees and the display screens 16a, 16b may display the same images, i.e., the system 10 being in the cloning mode. In this operational mode, two users sitting on opposite sides of the assembly may view the same images and have the same level of access to the system 10 by use of multiple input devices coupled to the ports 26. For instance, the system 10 may allow two users to play the same electronic game with each other simultaneously using two identical joysticks (not shown) coupled to the ports 26. Note that in order to accommodate use of this mode, means must be provided to electronically invert the image displayed by the rotated monitor.

The monitors 12a, 12b may include control buttons 28a, 28b for setting screen display parameters, such as brightness, contrast, etc., and speakers 25a, 25b. Alternatively, only one set of control buttons, say 28a, may be used to set screen display parameters of both monitors 12a, 12b. It is noted that each monitor may have any suitable number of control buttons and speakers. Also, each monitor may include additional input/output ports, such as headphone, microphone, and jacks, etc., which are not shown in FIG. 1 for brevity.

The input/output ports 26 may receive plugs and/or connectors for various applications, such as power, video/audio data stream, and input devices (keyboard, mouse, etc.). For instance, the system 10 may play video/audio signals sent by a computer through ports 26 that may include a high-definition multimedia interface or other suitable wireless communication ports, such as IR or RF ports. The ports 26 may include a DMS input port for dual monitors. As discussed above, the system 10 may be accessed by two users simultaneously. In such a case, the ports 26 may accommodate connection of a pair of mouse plugs and/or a pair of keyboard plugs or other types of control device plugs, such as joysticks for electronic games. Moreover, the base 24 may house computer electronics.

The display screens 16a, 16b may employ, but are not limited to, liquid crystal display (LCD), light emitting diode (LED), vacuum fluorescent display (VFD) or other types of display panels, eliminating the bulkiness of conventional desktop cathode ray tube monitors. The generation of images for display on the screens 16a, 16b may arise from various sources. In one embodiment, the monitors 12a, 12b may include two separate internal or external computers (not shown in FIG. 1), and the processing units of the computers may be linked to respectively generate independent images to be displayed on the screens 16a, 16b. In another embodiment, the generation of images for display on the screens 16a, 16b may arise from one or more processing units of a computer that sends the generated image signals to the monitors through the ports 26. In this embodiment, one video card may be connected to the two monitors (dual head) or two separate video cards may be respectively connected to the two monitors.

The lower section 22 of the post 19 may be secured to the base 24 by suitable fastening mechanisms. In an alternative embodiment, the lower section 22 and base 24 may form an integral body. In FIG. 1, the base 24 is shown to have a generally rectangular cross sectional shape. However, it is should be apparent to those of ordinary skill that the base can have other suitable cross sectional shape, such as oval, circular, triangular, etc.

As the monitors 12a, 12b pivot and/or rotate relative to the post 19, the center of gravity of the system 10 may also shift relative to the base 24. The dimension and shape of the base may be determined such that the center of gravity of the system 10 can be located within the base 24 as the monitors 12a, 12b pivot and/or rotate within the pivotal and/or rotational extremities.

One or more of the input/output ports 26 may be connected to a computer, such as PC 7, via a connection wire. The computer 7 may include a keyboard 8 and mouse 9. The computer 7 may be connected to more than one keyboard and mouse to simultaneously accommodate more than one user.

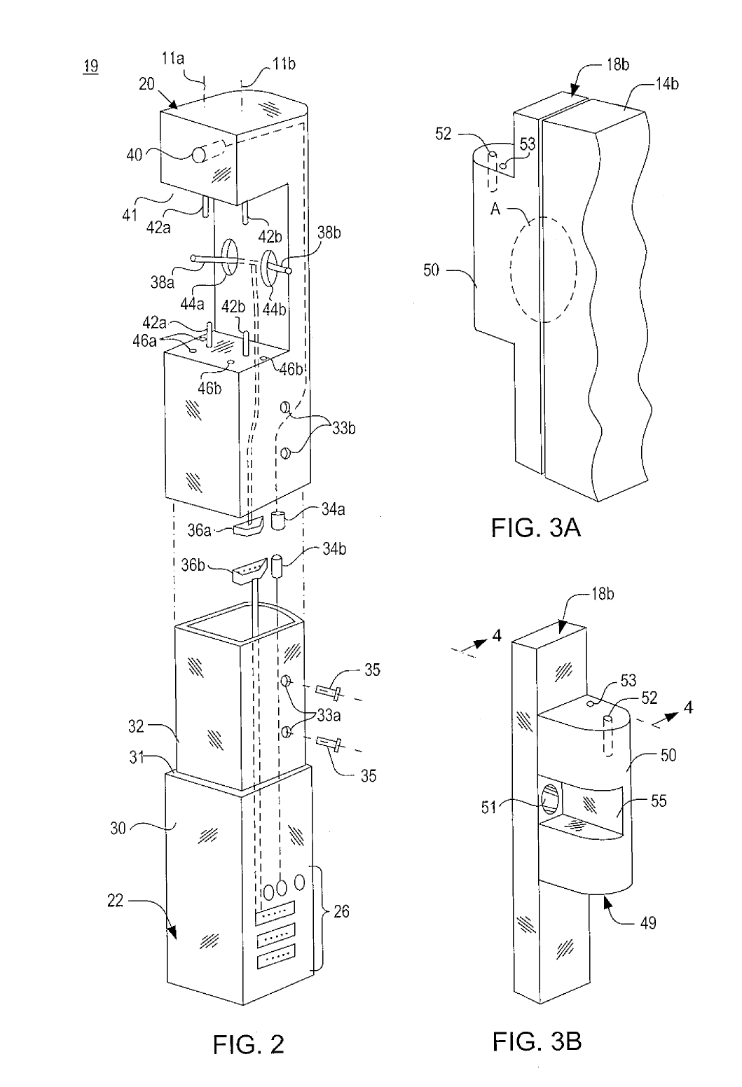

FIG. 2 shows an exploded perspective view of the post or stand assembly 19 in FIG. 1. FIG. 3A shows a schematic perspective view of the pivot arm 18b and frame 14b. FIG. 3B shows another schematic perspective view of the pivot arm 18b, seen from the backside thereof. As depicted, the post 19 may include an upper section 20 and a lower section 22 secured to the upper section by suitable fasters 35 passing through the holes 33a, 33b. The upper section 20 may be formed of an elongated hollow body having a recessed portion or slot 41 for receiving the pivot arms 18a, 18b (more specifically, the mounting protrusions 50 of the pivot arms) therein. The post 19 may be made of plastic or other suitable materials.

In FIG. 2, only two sets of holes 33a and 33b are shown. However, it should be apparent to those of ordinary skill that the post 19 may have more than two sets of holes arranged in the longitudinal direction of the post so that the user can adjust the location of the upper portion 20 relative to the lower section 22 along the longitudinal direction.

A camera 40 may be mounted in the wall of the upper section 20 and connected to a connector 34a which in turn is connected to one of the ports 26 via a plug 34b. In the cavity of the upper section 20 are cables 38a, 38b connected to one of the ports 26 via a connector 36a and a plug 36b. The cable 38b may pass through the hole 44b formed in the wall of the upper section 20 and through the hole 51 (FIG. 3B) formed in the pivot arms 18b to be connected to the frame 14b, and provide power and/or various electrical signals, such as video/audio and microphone (not shown in FIG. 2) signals, to the monitor 12b. The cable 38a may be connected to the monitor 12a in the similar manner. The connectors 36a and 36b are shown to be separate from the connectors 34a and 34b. However, an 80-pin connector may be used in place of the two separate connectors 34a and 36a.

The lower section 22 of the post 19 may include elongated hollow portions 30, 32. The upper portion 32 may be dimensioned to slip into the bottom portion of the upper section 20 so that the bottom end of the upper section 20 may engage and seat on the shoulder 31 in the lower section 22. The input/output ports 26 may be formed in the wall of the lower section 22. It should be apparent to those of ordinary skill that the ports 26 may include any suitable number of receptacles and plugs, such as 80 pin connectors, for communicating electrical signals therethrough.

The pivot arms 18a, 18b may be pivotally mounted to the upper section 20 by use of pivot rods 42a, 42b to be inserted into cavities 52 formed in the mounting protrusions 50 of the arms 18a, 18b. The pivot rods 42a and 42b may extend along the pivot axes 11a, 11b such that mounting protrusion 50 of the pivot arm 18b arranged in the slot 41 of the upper section 20 can pivot about the pivot axes. The mounting protrusion 50 may include one or more ball-nosed spring plungers 53 which act as detents to define the angular span of the pivot arm 18b. It should be apparent to those of ordinary skill that a ball-nosed spring plunger may be disposed in the bottom surface 49 of the mounting protrusion 50.

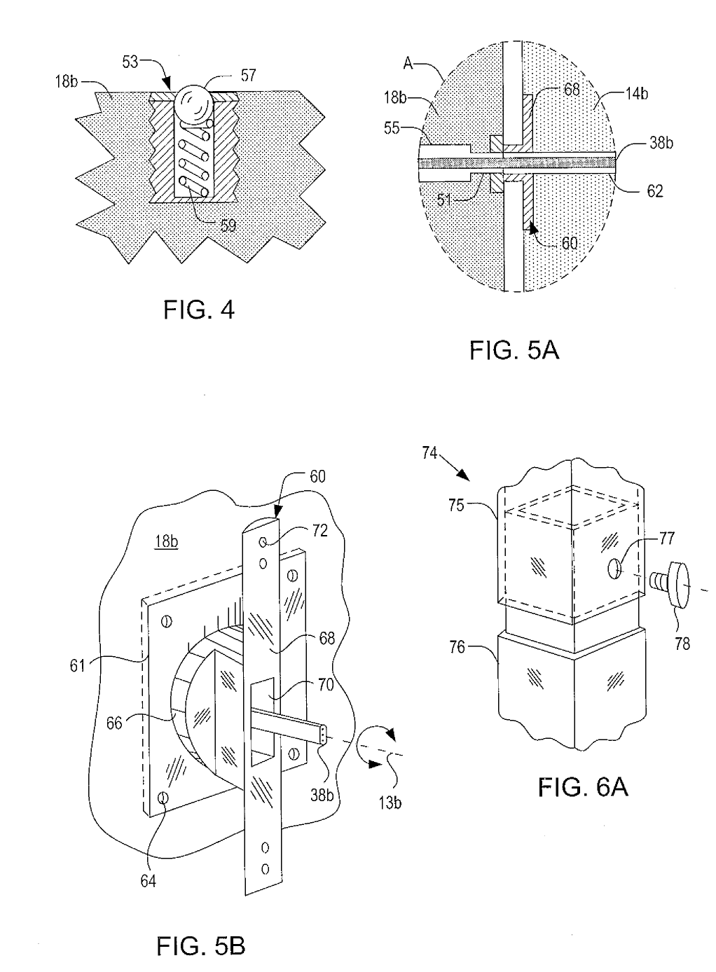

FIG. 4 shows a schematic cross sectional view of the pivot arm 18b, taken along the line 4-4 to illustrate the detailed structure of the ball-nosed spring plunger 53 secured in the arm 18b. As depicted, the plunger 53 may include a ball 57 that may roll on a surface of the upper section 20 before being clamped or locked down to mating cavities 46b (FIG. 2) by the compression spring 59. The locations of the mating cavities 46a, 46b may determine the angular spans of the pivot arms 18a, 18b relative to the post 19. Additional mating cavities may be formed in the upper section 20 along the path of the ball 57 so that the user can locate the pivot arms 18a, 18b at predetermined angular positions relative to the post 19.

It is noted that the mounting protrusion 50 may include a slot 55 through which the cable 38b passes, as depicted in FIG. 3B. FIG. 5A shows a schematic side cross sectional view of the region A in FIG. 3A. As depicted, the cable 38b passing through the hole 44b (shown in FIG. 2) formed in the upper section 20 may pass through the slot 55 and hole 51 formed in the arm 18b and through a mounting assembly 60 to the frame 14b. The frame 14b may include a cavity 62 formed therein to provide a passageway for the cable 38b.

The frame 14b may be rotatably mounted to the pivot arm 18b via the mounting assembly 60, allowing the user to rotate the frame 14b along the axis 13b. FIG. 5B shows a schematic perspective view of the mounting assembly 60, wherein the frame 14b is not shown therein for brevity. As depicted, the mounting assembly 60 may include an assembly base (or, shortly base) 61 affixed to the pivot arm 18b by suitable fasteners 64 and a turret 66 rotatably coupled to the base 61. The mounting assembly 60 may also include an elongated bracket 68 having a flat surface affixed to the frame 14b by fasteners passing through the holes 72 formed in the bracket 68. The turret 66 may rotate relative to the pivot arm 18b, allowing the frame 14b to rotate about an axis 13b. The mounting assembly 60 may include a slot 70 forming a passageway for the cable 38b. It is noted that the pivot arm 18a and monitor 12a have the similar structures as the pivot arm 18b and monitor 12b. As such, a detailed description of the pivot arm 18a and monitor 12a is not repeated in the present document.

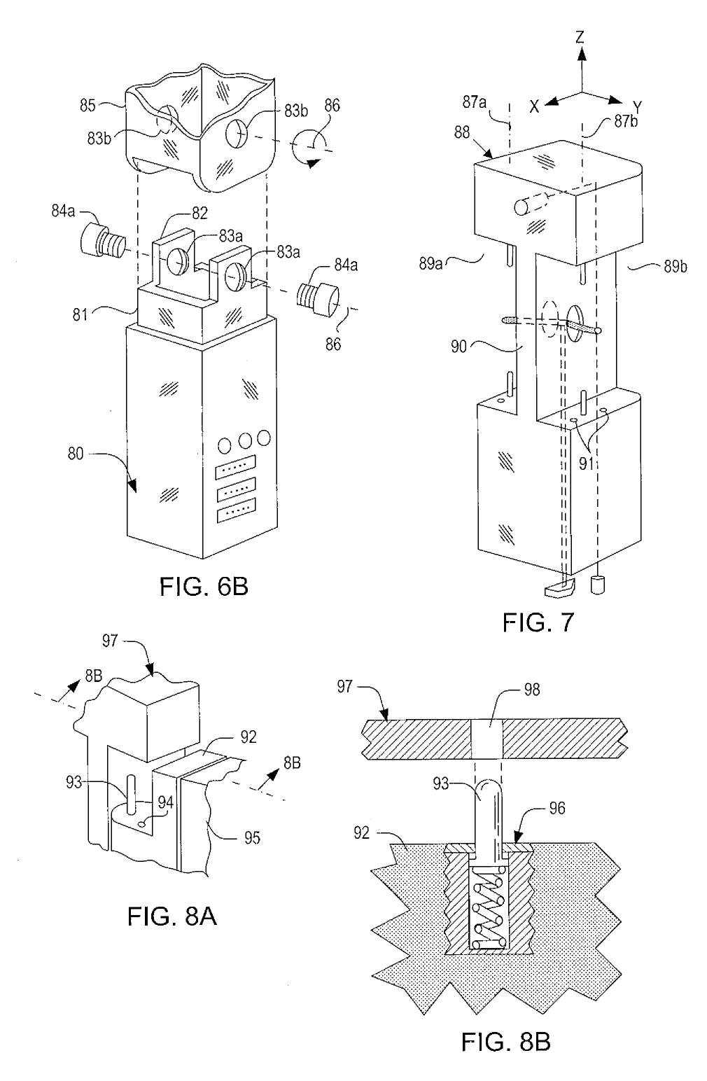

FIG. 6A shows a schematic exploded perspective view of another embodiment of a post of a type that might be used in the system of FIG. 1 in accordance with the present invention. As depicted, the post 74 may have a similar structure as the post 19 in FIG. 2, with the difference that the post 74 may have a threaded hole 77 for receiving a male portion of a knob 78. The top portion of the lower section 76 may be dimensioned to slip into the upper section 75. The user may slide the upper section 75 relative to the lower section 76 so that the upper section 75 is positioned at an intended location. Then, the user may tighten the knob 78 so that the knob secures the upper section 75 to the lower section 76. The knob 78 enables the user to adjust the location of the upper section 75 relative to the lower section 76 along the longitudinal direction of the post 74.

FIG. 6B shows an exploded perspective view of another embodiment of a post of a type that might be used in the system 10 of FIG. 1. For simplicity, electrical wires are not shown in FIG. 6B. As depicted, the post may be similar to the post 19 in FIG. 2, with the difference that the upper section 85 of the post can be tilted with respect to the lower section 80. The upper portion 81 of the lower section 80 may include protrusions 82 with threaded holes 83a. The upper section 85 may include holes 83b to be aligned with the threaded holes 83a when assembled so that suitable fasteners or knobs 84a passing through the holes 83b can be engaged into the threaded holes 83a. The user can adjust the angular deflection of the upper section 85 relative to the lower section 80 about an axis 86 thereby the display screens can be tilted about an axis parallel to the axis 86.

FIG. 7 shows a schematic perspective view of still another embodiment of a post of a type that might be used in the system 10 of FIG. 1. For brevity, only the upper section 88 of the post is shown in FIG. 7. As depicted, the upper section 88 may be similar to the upper section 20 in FIG. 2, with the difference that the recessed portion or slots 89a, 89b extend along the width of the post in the x-direction and the slots 89a, 89b are separated by a middle section 90. It is noted that the upper section 88 may allow the pivot arms to rotate up to 180 degrees about the axes 87a and 87b, i.e., the mating cavities 91 for the ball-nosed spring plungers may be located to set the angular interval of the pivot motion up to 180 degrees. Alternatively, additional mating cavities may be formed in the upper section 88 along the path of the ball so that the user can locate the pivot arms 18a, 18b at predetermined angular positions relative to the post 88.

FIG. 8A shows a schematic perspective view of an embodiment of a pivot arm 92 of a type that might be used in the system 10 of FIG. 1. FIG. 8B shows a schematic cross sectional view of the pivot arm 92, taken along the line 8B-8B. For the purpose of illustration, the pivot arm 92 and frame 95 are shifted downward relative to the post 97. The pivot arm 92, frame 95, and the post 97 may be similar to the pivot arm 18b, frame 14b, and post 19 in FIG. 1, with the differences that the pivot arm 92 may include a pair of pivot rods 93 and the post 97 may include a pair of holes 98 for receiving the pivot rods 93 when assembled. The pivot rod 93 may be included in a pivot assembly 96 that may have a similar structure as that of a conventional round-nosed spring plunger. The pivot rod 93 can be retracted so that the pivot arm 92 may be detachably and pivotally secured to the post 97.

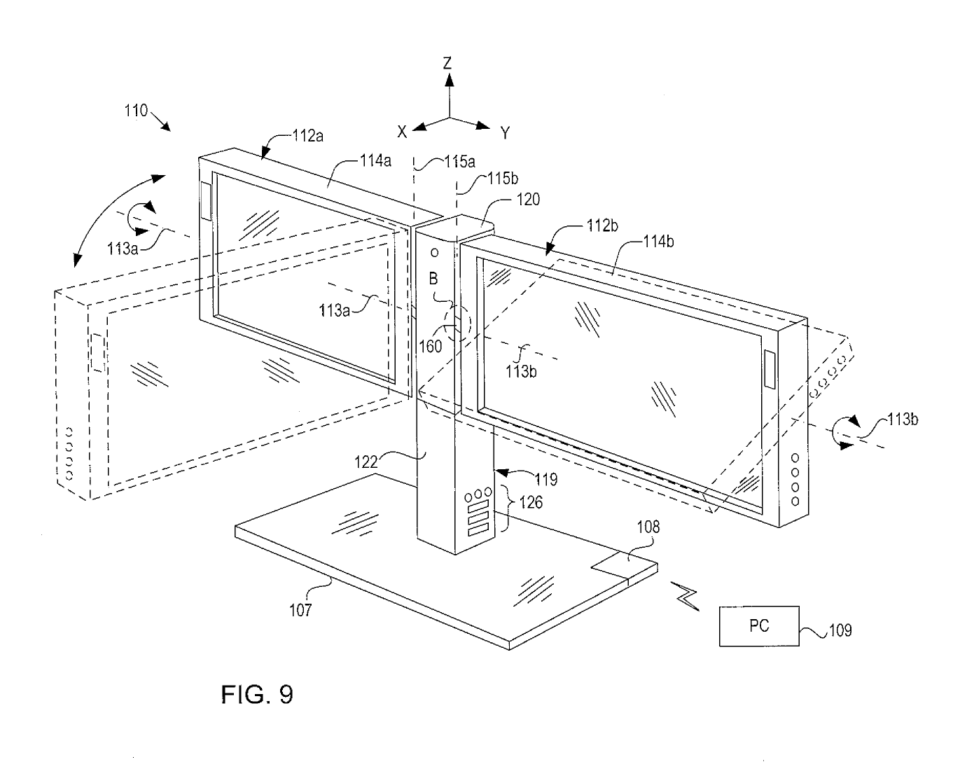

Referring to FIG. 9, there is shown at 110 a perspective view of a twin view system in accordance with another embodiment of the present invention. As depicted, the system 110 may be similar to the system 10 in FIG. 1, with the differences that the upper section 120 of the post 119 may have a generally uniform cross sectional shape along its longitudinal direction (or, equivalently z-direction) and that the monitors 112a, 112b may be rotatably mounted to the upper section 120 via mounting assemblies 160. The mounting assemblies 160 may allow each of the monitors 112a, 112b to have the dual motion relative to the post 119, i.e., the monitor 112a (or 12b) may have a pivotal motion about the axis 115a (or 115b) and a rotational motion about the axis 113a (or 113b).

The input/output (or communication) ports 126 can be used to communicate signals with a computer 109 via a cable (not shown in FIG. 9). In an alternative embodiment, the base 107 may have a wireless signal receiver 108 that can communicate wireless signals, such as RF signals, with a computer 109 having a wireless signal sender. In another alternative embodiment, a computer may be installed in the base 107 or in one of the monitors 112a, 112b. In this embodiment, the receiver 108 may receive wireless signals sent by a signal sender(s) in a wireless control device, such as mouse and keyboard (not shown in FIG. 9).

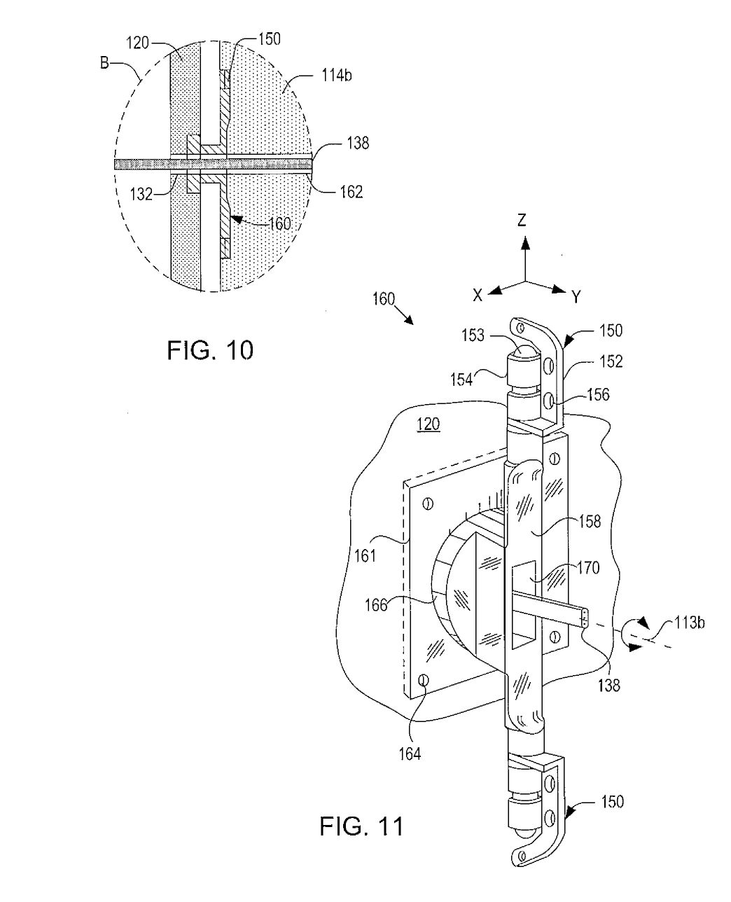

FIG. 10 shows a schematic cross sectional view of the region B in FIG. 9, taken along the y-z plane. FIG. 11 shows a schematic perspective view of the mounting assembly 160. For brevity, the frame 114b of the monitor 112b is not shown in FIG. 11. As depicted, the frame 114b may be mounted to the upper section 120 via the mounting assembly 160. The mounting assembly 160 may include an assembly base (or, shortly base) 161 secured to the upper section 120 by suitable fasteners 164 and a turret 166 rotatably coupled to the base 161 to rotate relative to the base 161 about the axis 113b. The mounting assembly 160 may also include an elongated bracket 158 having a pair of pins 153 formed at both ends thereof and a pair of hinge mechanisms 150 pivotally attached to the pins 153. Each hinge mechanism 150 may rotate relative to the bracket 158 about the z-axis and include knuckles 154 pivotally holding the pin 153 and a leaf 152 secured to the knuckles 154. The leaf 152 may have holes 156 so that suitable fasteners for securing the frame 114b to the leaf 152 can pass therethrough.

The upper section 120 may include a hole 132 through which the cable 138 extending from the upper section 120 passes. The cable 138 may also pass through the slot 170 formed in the mounting assembly 160 and a hole 162 formed in the frame 114b. The cable 138 may provide power and/or various electrical signals, such as video/audio signals, to the monitor 112b.

In an alternative embodiment, the lower section 122 and upper section 120 may have the similar connection mechanism as shown in FIG. 6B so that the upper section 120 may be tilted with respect to the lower section 122. For brevity, this embodiment is not repeated in the present document.

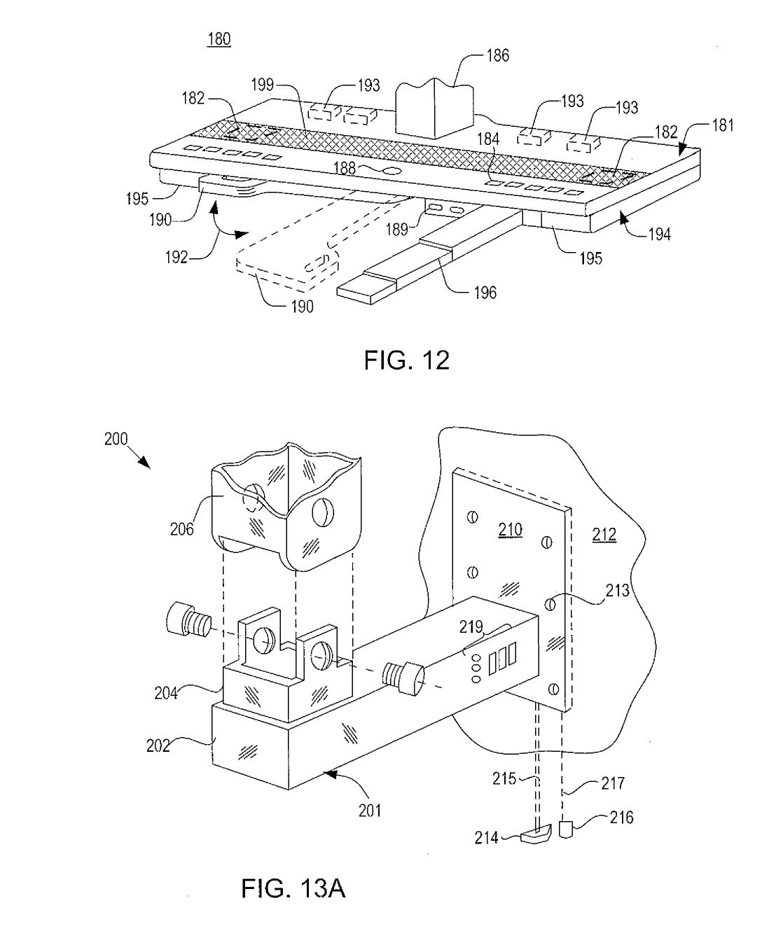

FIG. 12 is a perspective view of an embodiment of a base 180 of a type that might be used in a twin view system in accordance with the present invention. For simplicity, detailed description of the post and monitors, which are similar to those in FIG. 1, are not shown in FIG. 12. The base 180 may include one or more of various components: speakers 182; weights 195; one or more balance legs 190 and 196; and two sets of control buttons 184 for setting screen display parameters, such as brightness, contrast, etc.

As the monitors pivot and/or rotate relative to the base 180, the center of gravity of the twin view system may shift relative to the base 180. The shift may be maximum when both monitors 12a, 12b, for instance, are respectively rotated about the axes 11a and 11b by 90 degrees, thereby the screens are positioned to face each other. When the center of gravity is located near the edges of the base 180, the twin view system can be tipped over by an inadvertent force applied thereto. To increase the stability of the system, one or more balance legs 190 and 196 can be used. The pivoted balance leg 190 may be hinged at one end thereof by a knob 188 so that the leg can be disposed in the base 180 when not in use and swung out of the base as indicated by an arrow 192 when used. The dimension and shape of the balance leg 190 may be determined such that the center of gravity of the system can be located within the base 180 and leg 190 regardless of the monitors' position relative to the base. Alternatively, a telescopic balance leg 196 may be included in the base 180, wherein the leg 196 can be folded into the base when not in use. When extended, the telescopic balance leg 196 would have the similar functions as those of the pivoted balance leg 190.

In an alternative embodiment, the base 180 may include two pivoted balance legs that can rotate in opposite directions. In another alternative embodiment, the telescopic balance leg 196 may be used in place of the pivoted leg 190. It should be apparent to those of ordinary skill that other suitable combination of pivoted balance legs and/or telescopic balance legs may be included in the base without deviating from the spirit of the present invention.

As a variation, the base 180 may also include USB ports 189 and other various ports 193 for communicating electrical signals: input/output ports for audio signals, a microphone port, a DMS port, and a power input port, etc. The ports 193 may be used in place of the ports 26 (FIG. 1) mounted in the post 19 or connected to the ports 26 so that the user can use either of the ports 26 and 193. It should be apparent to those of ordinary skill that other suitable ports may be included in the base without deviating from the spirit of the present invention.

As depicted in FIG. 12, the base 180 may include a space surrounded by an upper case 181 and a lower case 194 and have components, such as weights 195 and speakers 182, in the space. The upper case 181 may include a perforated portion 199. The weights 195 may reduce the shift of the center of gravity relative to the base when the monitors pivot and/or rotate relative to the base 180, thereby to prevent the twin view system from tipping over by an inadvertent force applied thereto. A microphone may be installed in the knob 188 or installed at a suitable location in the base. Likewise, the other components, such as balance legs and weights, included in the base 180 may be disposed at suitable locations in the base without deviating from the spirit of the present invention.

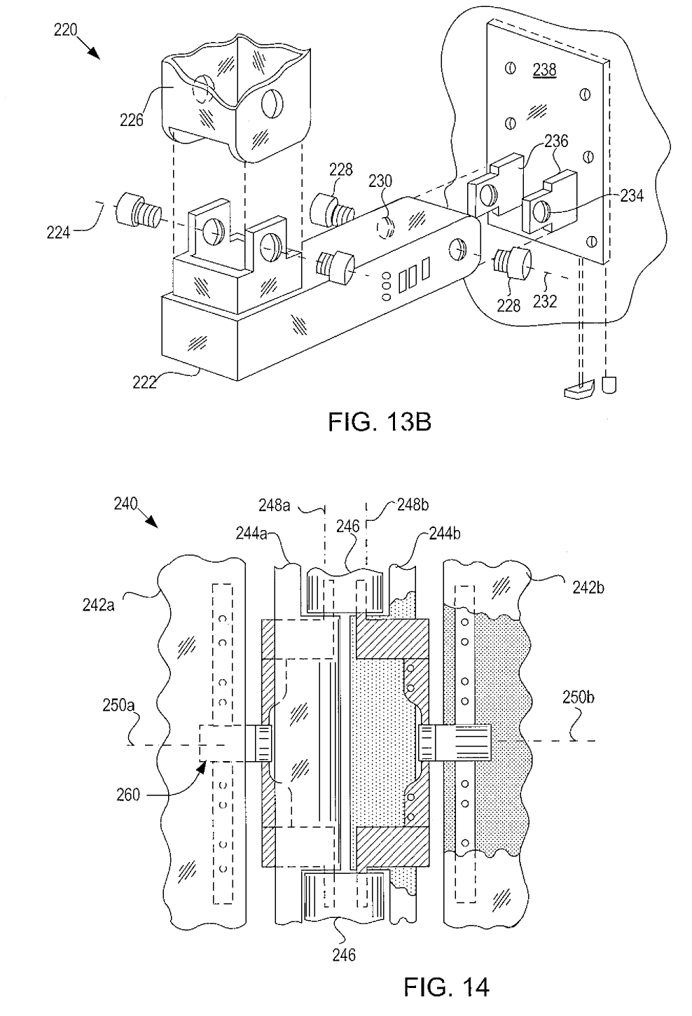

FIG. 13A is an exploded perspective view of another embodiment of a post or stand assembly 200 in accordance with the present invention. As depicted, the post 200 may be similar to the post in FIG. 6B, with the differences that the base 210 is affixed to a wall 212 by suitable fasteners 213 and the lower portion 202 of the lower section 201 extends substantially perpendicular to the longitudinal axis of the upper section 206. The lower section 201 may be secured to the base 210 or form an integral body with the base 210. The connectors 214 and 216 may be coupled to the monitors (not shown in FIG. 13A) via cables 215 and 217 that pass through the base 210, lowers section 201 and upper section 206. For simplicity, only the portions of the cables 215 and 217 behind the wall 212 are shown in FIG. 13A. The connectors 214 and 216 may be coupled to a computer (not shown in FIG. 10). As a variation, the lower section 201 may include communication ports 219 so that the cables extend from the monitors to the ports 219.

FIG. 13B is an exploded perspective view of yet another embodiment of a post or stand assembly 280 in accordance with the present invention. As depicted, the post 220 may be similar to the post 200 in FIG. 13A, with the difference that the lower section 222 of the post may be tilted with respect to the base 238. The base 238 may include two protrusions 236 with threaded holes 234. The lower section 222 may include holes 230 to be aligned with the threaded holes 234 when assembled so that suitable fasteners or knobs 228 passing through the holes 230 can be engaged into the threaded holes 234. The user can adjust the angular deflection of the lower section 222 relative to the base 238 about an axis 232 thereby the display screens can be tilted about an axis parallel to the axis 232.

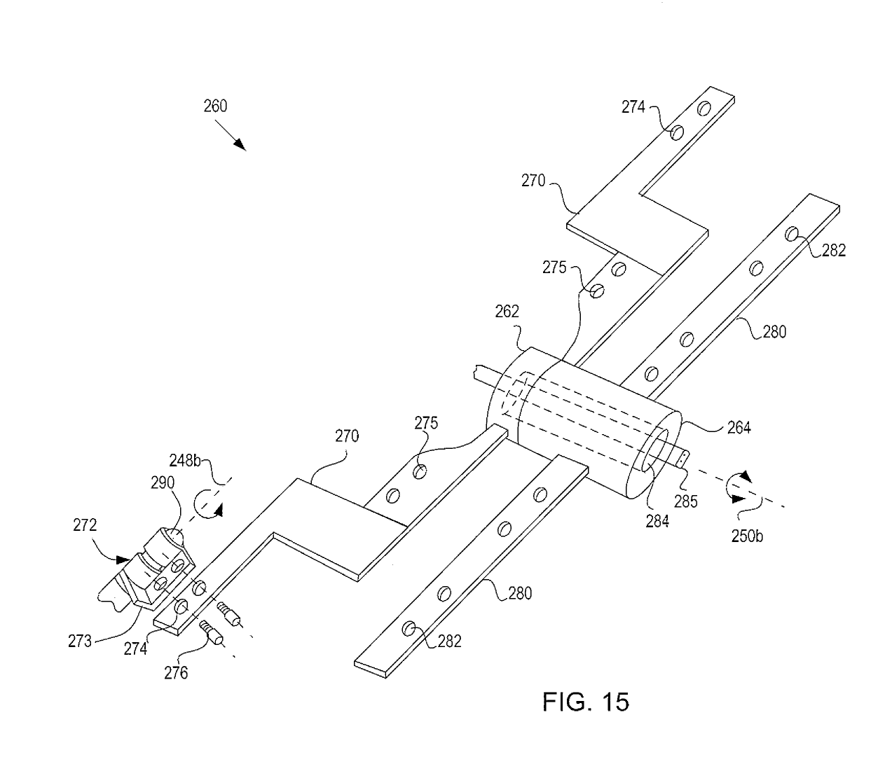

FIG. 14 is a broken partial cut away front view of an alternative embodiment of a twin view system 240 in accordance with the present invention. FIG. 15 is a perspective view of the mounting assembly 240 in FIG. 14. The system 240 is similar to the system 10 in FIG. 1, with the difference that the mounting assemblies 260 have a structure different from that of the assembly 60. As depicted, the system 240 includes: two monitors 242a and 242b; two pivot arms 244a and 244b rotatably secured to the monitors 242a and 242b, respectively; and a post 246 to which the pivot arms 244a and 244b are pivotally secured. The pivot arms 244a and 244b can respectively pivot about axes 248a and 248b passing through the pins 290 of the hinge mechanisms 272. The monitors 242a and 242b can respectively rotate about the axes 250a and 250b relative to the pivot arms 244a and 244b.

A depicted in FIG. 15, the mounting assemblies 260 includes a first cylindrical member 262 and a second cylindrical member 264 rotatably secured to the first cylindrical member. Two arms or brackets 270 have proximal ends secured to the first cylindrical member 262 and distal ends with holes 274 formed therein. Suitable fasteners 276 can be used to secure the distal ends of the brackets to two hinge mechanisms 272. More specifically, the hinge mechanism 272 includes a pin 290 secured to the post 246 and a leaf 273 to which the distal end of the bracket 270 are secured by the fasteners 276. For simplicity, only one hinge mechanism is shown in FIG. 15. However, it should be apparent to those of ordinary skill that a similar hinge mechanism may be secured to the distal end of the other bracket 270. The brackets 270 may have additional holes 275 through which fasteners for securing the brackets to the hinge arm 244b (or 244a) pass. The second cylindrical member 264 may have two arms or brackets 280 secured thereto. The brackets 280 have holes 282 through which fasteners for securing the brackets 280 to the monitor 242b (or 242a) pass.

It is noted that the first and second cylindrical members 262, 264 have a hole 284 extending the entire length of the members, i.e., the cylindrical members 262, 264 are generally hollow cylinders. A cable 285 for providing power and/or various electrical signals, such as video/audio and microphone signals, to the monitor 242b may pass through the hole 284 formed in the cylindrical members 262, 264.

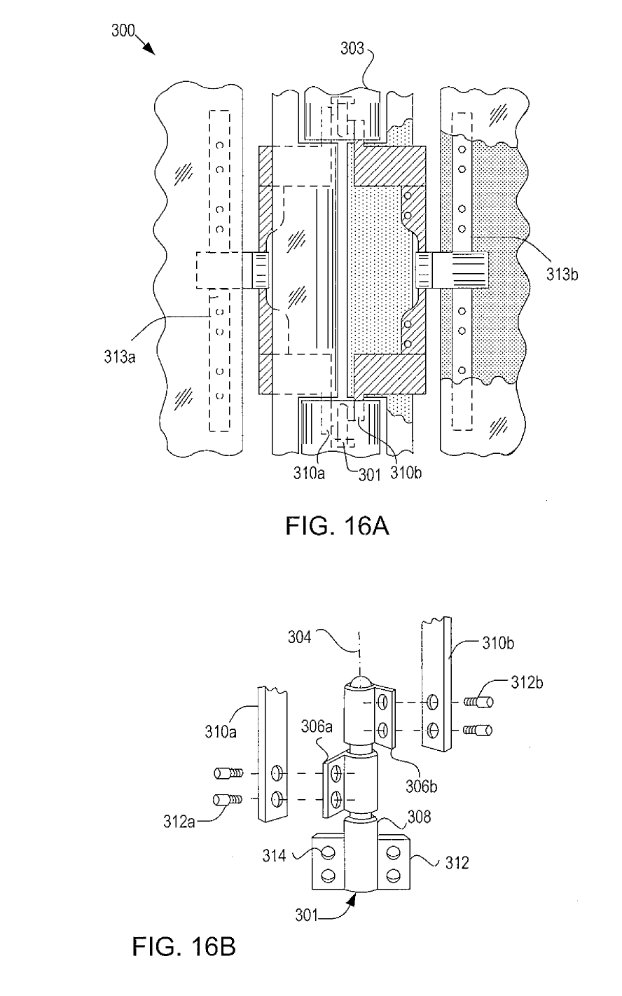

FIG. 16A is a broken partial cut away front view of an alternative embodiment of a twin view system 300 in accordance with the present invention. FIG. 16B is an exploded view of an embodiment of a hinge mechanism 301 in the system 300 of FIG. 16A. As depicted, the system 300 is similar to the system 240 of FIG. 14, with the difference that the two mounting assemblies 313a, 313b are pivotally secured to the hinge mechanism 301. More specifically, the tips of flanges 310a, 310b are secured to the leaves 306a, 306 by fasteners 312a, 312b such that the mounting assemblies 313a, 313b can pivot about the axis 304. Secured to the base 308 of the hinge mechanism 301 are wings 312 that are affixed to the post 303.

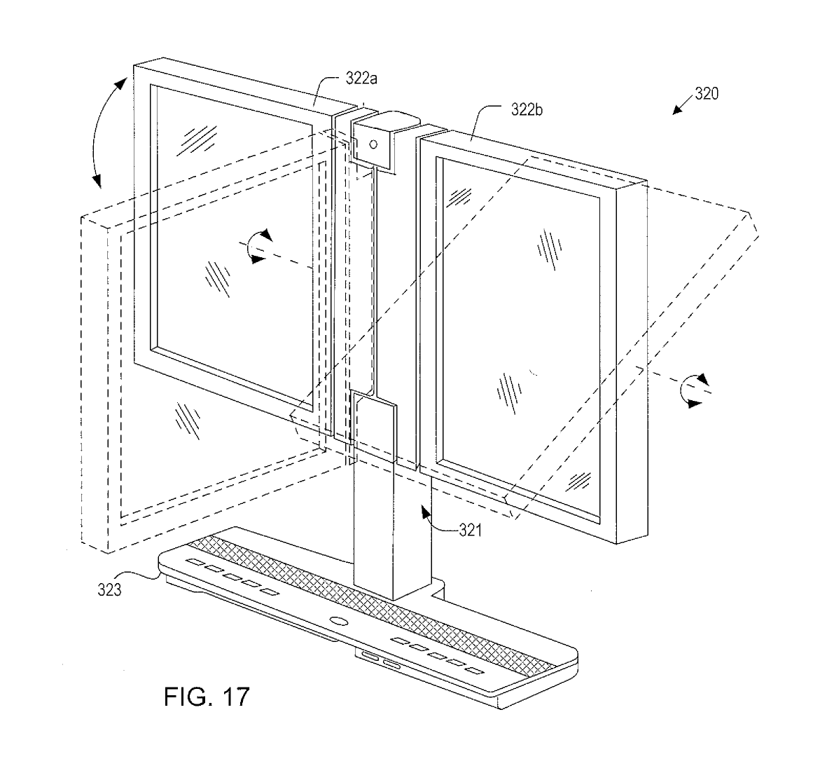

FIG. 17 shows a perspective view of a twin view system 320 in accordance with yet another embodiment of the present invention. As depicted, the system 320 is similar to the system 10 in FIG. 1, with the differences that the monitors 322a and 322b are arranged for portrait-oriented display and that the base 323 includes various components and ports, as depicted in FIG. 12. Hereinafter, for brevity, the ports are shown to be included in the base only. However, it should be apparent to those of ordinary skill that the ports can be also formed in the post 19, as shown in FIG. 1. Also, the monitors 322a and 322b may have additional components, such as speakers or control buttons, as shown in FIG. 1.

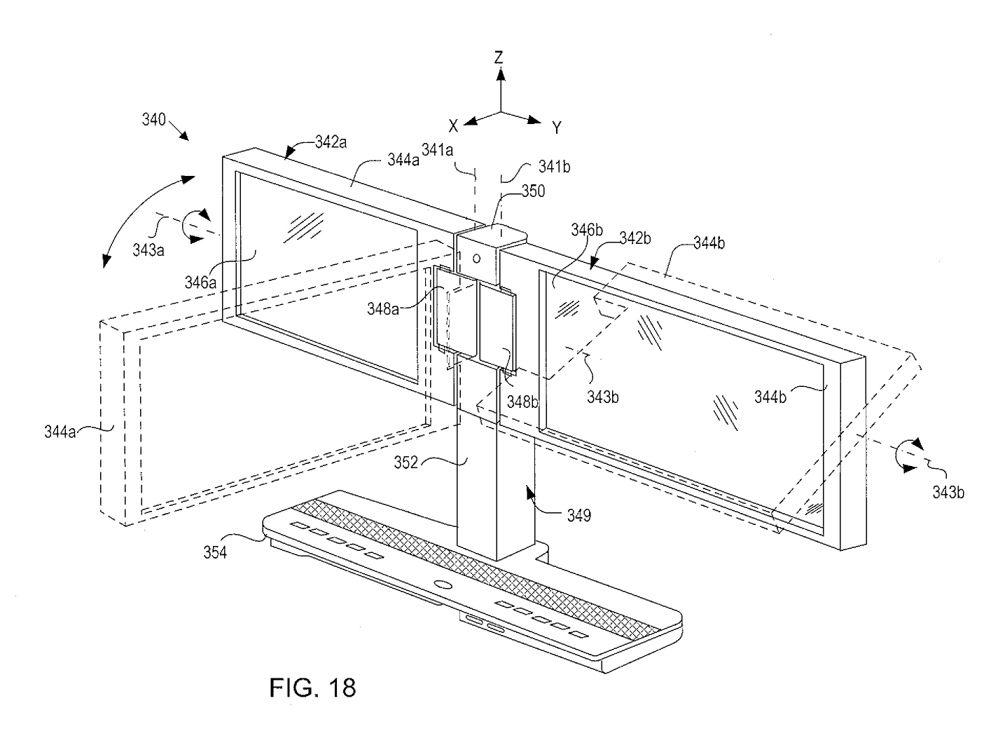

FIG. 18 shows a perspective view of a twin view system 340 in accordance with a further embodiment of the present invention. The system 340 includes: a post 349 having an upper section 350 and a lower section 352; a pair of pivot arms 348a, 348b pivotally mounted to the upper section 350 and rotatable about axes 341a, 341b; a base 354; and a pair of monitors 342a, 342b rotatably mounted to the pivot arms 348a, 348b, respectively. Each monitor may include a display screen 346a (or 346b) and a frame 344a (or 344b) for supporting the display screen.

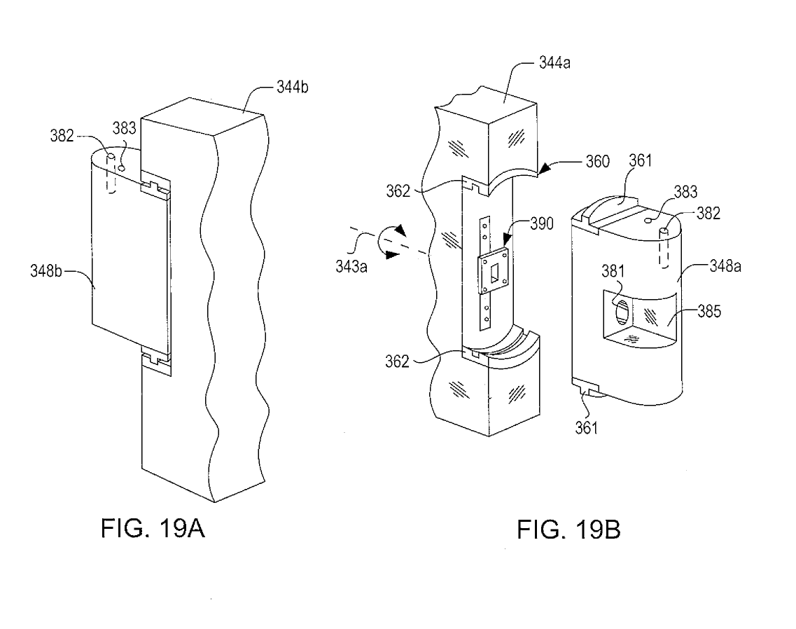

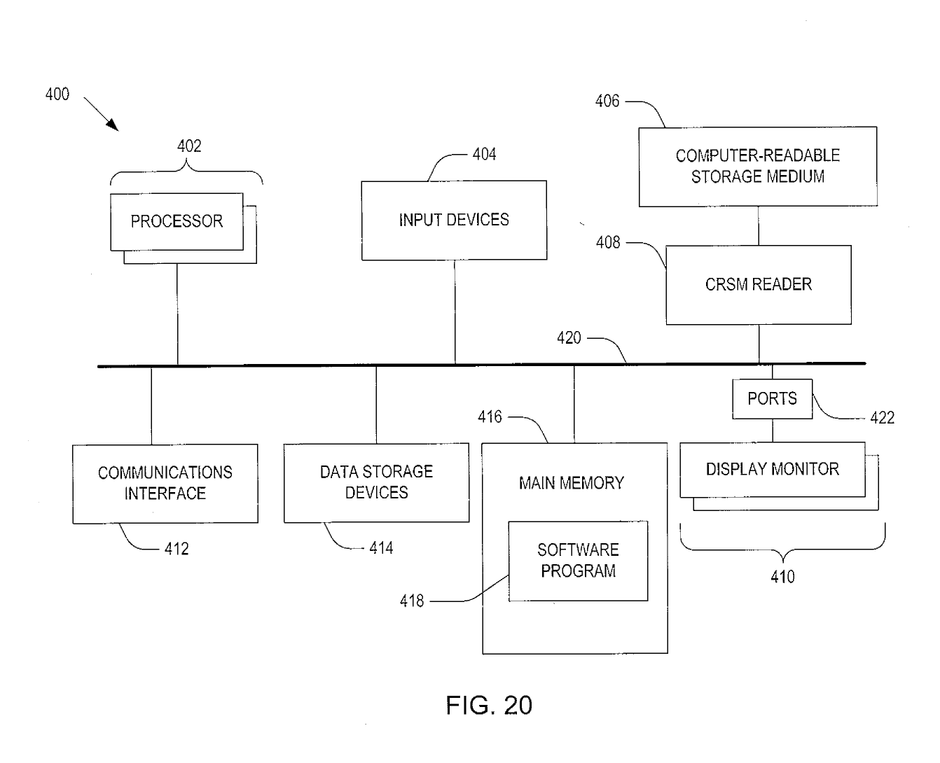

FIG. 19A shows a schematic perspective view of the pivot arm 348b and the frame 344b of the system in FIG. 18. FIG. 19B shows another schematic perspective view of the pivot arm 348a and the frame 344a, wherein the pivot arm 348a is shown to be disengaged from the frame 344a for the purpose of illustration. As depicted, the mounting assembly 390 is similar to the assembly 60 (FIG. 5B) and used to rotatably mount the frame 344a to the pivot arm 348a so that the frame 344a can rotate about the axis 343a. The cable extending from the base may pass through the slot 385 and the hole 381 formed in the pivot arm 348a. The pivot arm 348a may include one or more ball-nosed spring plungers 383 which act as detents to define the angular span of the pivot arm 348a.

The pivot arm 348a and frame 344a include two guidance tracks 360, each track having a prominence 361 secured to the pivot arm 348a and a depression 362 secured to the frame 344a. The guidance tracks 360 may be formed of preferably, but not limited to, formed of metal and provide adequate traction between the prominence and depression so that the frame 344a can be held at the intended tilting angle around the axis 343a. The guidance tracks 360 also prevent the monitors from rotating along the x-axis (FIG. 18), thereby to relieve the mechanical load on the mounting assembly 390. As a variation, the prominence can be secured to the frame 344a while the depression can be secured to the pivot arm 348a.

FIG. 20 shows a computer 400 of a type that might be employed in accordance with the present invention. In one embodiment, the monitors 410 may be separated from the other components of the computer 400 and connected to the other components through the ports 422 that may correspond to the ports 26 (FIG. 1), 126 (FIG. 9), and 219 (FIG. 13A). As discussed above, the ports 422 may include wireless communication ports, such as RF or IR port, as well as hard-wired connection ports. The computer 400 of FIG. 20 may have less or more components to meet the needs of a particular application. As shown in FIG. 20, the computer may include one or more processors 402 including CPUs and GPUs. The computer may have one or more buses 420 coupling its various components. The computer may also include one or more input devices 404 (e.g., keyboard, mouse, joystick), a computer-readable storage medium (CRSM) 406, a CRSM reader 408 (e.g., floppy drive, CD-ROM drive), a communication interface 412 (e.g., network adapter, modem) for coupling to a network, one or more data storage devices 414 (e.g., hard disk drive, optical drive, FLASH memory), and a main memory 416 (e.g., RAM). Software embodiments 418 may be stored in a computer-readable storage medium 306 for reading into a data storage device 414 or main memory 416.

In some embodiments, one of the monitors of FIGS. 1-19B may include a computer 400 and the twin view system may be used as a portable computer. For instance, the monitors 12a and 12b, pivot arms 18a and 18b, and the upper section 20 of the post 19 (FIG. 1) can be carried as a portable computer unit. For another instance, the monitors 112a and 112b and the upper section 120 of the post 119 (FIG. 9) can be carried as a portable computer unit. For yet another instance, the monitors 242a and 242b, pivot arms 244a and 244b, and the upper section 246 of the post (FIG. 14) can be carried as a portable computer unit. For still another instance, the monitors 322a and 322b and the upper section of the post 321 (FIG. 17) can be carried as a portable computer unit.

It is noted that each monitor and/or post may include at least one attitude sensor that can sense the attitude of the monitor. When the monitor is rotated about an axis, say 13b (FIG. 1), by 180 degrees, the displayed image should be also rotated by 180 degrees. Upon sensing the attitude of the monitor, the sensor may send a signal to a computer so that the images transmitted from the computer and displayed on the monitor can be properly rotated. As a variation, a suitable control mechanism, such as a button, can be installed on the twin display system, allowing a user to rotate the image manually.

It is noted that the computer systems in FIGS. 1-20 can provide the same level of access to the system for two users simultaneously and allow the two users to view face to face the identical screen shot or even a specific pixel with an easy screen pivoting and/or rotation.

Notwithstanding that the present invention has been described above in terms of several alternative embodiments, it is anticipated that still other alterations and modifications will become apparent to those of ordinary skilled in the art after having read this disclosure. It is therefore intended that such disclosure be considered illustrative and not limiting, and that the appended claims be interpreted to include all such alterations, modifications and embodiments as fall within the true spirit and scope of the invention.

What is claimed is:

1. A system for displaying a plurality of images, comprising:
a hollow post adapted for connection to a support means and having a recessed portion;
a pair of pivot arms including mounting protrusions pivotally mounted in said recessed portion, each said pivot arm being adapted to pivot about a first axis substantially parallel to a longitudinal axis of said hollow post;
a pair of mounting assemblies respectively affixed to said pivot arms; and
a pair of monitor frames respectively secured to said mounting assemblies,
wherein each said mounting assembly is adapted to allow one of said monitor frames to rotate relative to said post about a second axis substantially perpendicular to said first axis.

2. A system as recited in claim 1, wherein each said mounting assembly includes:
an assembly base affixed to one of said pivot arms;
a turret mounted to said assembly base and rotatable about said second axis relative to said assembly base; and
an elongated bracket affixed to said turret and one of said monitor frames.

3. A system as recited in claim 1, wherein said hollow post includes a plurality of pivot rods extending into said recessed portion along said first axis and said pivot arms include a plurality of cavities for receiving said pivot rods.

4. A system as recited in claim 1, wherein each said pivot arm includes a plurality of pivot rods extending along said first axis and said hollow post includes a plurality of holes for receiving said pivot rods.

5. A system as recited in claim 1, further comprising:
two pairs of hinge mechanisms affixed to said hollow post, each said pair of hinge mechanisms arranged substantially along said first axis,
wherein each said mounting assembly includes:
a first hollow cylindrical member;
a pair of first brackets, each said first bracket having a proximal end secured to said first hollow cylindrical member and a distal end rotatably secured to one of said pairs of hinge mechanisms;
a second hollow cylindrical member rotatably secured to said first hollow cylindrical member and rotatable about said second axis relative to said first hollow cylindrical member; and
a pair of second brackets, each said second bracket being secured to said second hollow cylindrical member and to one of said monitor frames.

6. A system as recited in claim 1, wherein each said pivot arm includes one or more ball-nosed spring plungers and said hollow post includes one or more mating cavities for receiving balls of said plungers, whereby said plungers and said balls form one or more detent mechanisms.

7. A system as recite in claim 1, further comprising a camera mounted in a wall of said hollow post.

8. A system as recited in claim 1, wherein each said monitor is arranged for portrait-oriented display.

9. A system as recited in claim 1, wherein said support means includes:
an other hollow post having a first and a second end, said first end being secured to said hollow post; and
a base secured to said second end.

10. A system as recited in claim 9, further comprising:
one or more communication ports disposed in a wall of said other hollow post; and
one or more cables running through said hollow post and said other hollow post to connect said communication ports to said monitor frames.

11. A system as recited in claim 9, wherein said first end is rotatably secured to said other hollow post thereby to allow said hollow post to be tilted relative to said other post.

12. A system as recited in claim 9, wherein said base is secured to a wall and said second end is rotatably secured to said base to allow said other hollow post to be tilted relative to said base and said other hollow post includes a middle portion extending in a direction substantially normal to a longitudinal axis of said hollow post.

13. A system as recited in claim 9, wherein a top portion of said other hollow post is dimensioned to slide into said hollow post and said top portion is secured to said hollow post by a tunable knob engaged into a threaded hole formed in said hollow post.

14. A system as recited in claim 9, wherein said base includes a balance mechanism for preventing said system from tipping over, said balance system having one or more of the group consisting of a balance leg hinged at one end thereof to said base, a telescopic balance leg, and at least one weight.

15. A system as recited in claim 9, wherein said base includes one or more of the group consisting of a microphone, control buttons for setting display parameters of monitors, speakers, and a wireless signal receiver for receiving communication signals.

16. A system as recited in claim 1, wherein one of said monitor frames includes a computer.

17. A system as recited in claim 1, further comprising two guidance track mechanisms, each said guidance track mechanism including a depression formed one of said pivot arms and a prominence formed on a corresponding one of said monitor frames and configured to slidably engage said depression to thereby relieve mechanical load on a corresponding one of said mounting assemblies.

18. A system for displaying a plurality of images, comprising:
a hollow post adapted for connection to a support means;
a pair of mounting assemblies affixed to said hollow post; and
a pair of monitor frames respectively secured to said mounting assemblies,
wherein each said mounting assembly is adapted to allow a monitor to pivot about a first axis substantially parallel to the longitudinal axis of said hollow post and to rotate about a second axis substantially perpendicular to said first axis.

19. A system as recited in claim 18, wherein each said mounting assembly includes:
an assembly base affixed to said hollow post;
a turret rotatably mounted to said assembly base;
an elongated bracket secured to said turret; and
a pair of hinge mechanisms pivotally attached to both ends of said bracket, one of said monitor frames being affixed to said hinge mechanisms.

20. A system as recited in claim 18, wherein each said monitor is arranged for portrait-oriented display.

21. A system as recited in claim 18, wherein said support means includes:
an other hollow post having a first and a second end, said first end being secured to said hollow post; and
a base secured to said second end.

22. A system as recited in claim 21, further comprising:
one or more communication ports disposed in a wall of said other hollow post; and
one or more cables running through said hollow post and said other hollow post to connect said communication ports to said monitors.

23. A system as recited in claim 21, wherein said first end is rotatably secured to said other hollow post thereby to allow said hollow post to be tilted relative to said other post.

24. A system as recited in claim 21, wherein said base is secured to a wall and said second end is rotatably secured to said base to allow said other hollow post to be tilted relative to said base and said other hollow post includes a middle portion extending in a direction substantially normal to a longitudinal axis of said hollow post.

25. A system as recited in claim 21, wherein said base includes a balance mechanism for preventing said system from tipping over due to an external force applied thereto, said balance system having one or more of the group consisting of a balance leg hinged at one end thereof to said base, a telescopic balance leg, and at least one weights.

26. A system as recited in claim 21, wherein said base includes one or more of the group consisting of a microphone, control buttons for setting display parameters of monitors, speakers, and a wireless signal receiver for receiving communication signals.
